(19) United States
(12) Patent Application Publication
(10) Pub. No.: US 2024/0258025 A1
(43) Pub. Date: Aug. 1, 2024

(54) REACTOR, CONVERTER, AND POWER CONVERTER DEVICE

(71) Applicant: Sumitomo Wiring Systems, Ltd., Yokkaichi-shi (JP)

(72) Inventors: Kota TAKEHIRO, Yokkaichi-shi (JP); Naotoshi FURUKAWA, Yokkaichi-shi (JP); Keiichiro YAMAMOTO, Yokkaichi-shi (JP); Shou SUGITA, Yokkaichi-shi (JP)

(73) Assignee: Sumitomo Wiring Systems, Ltd., Yokkaichi-shi (JP)

(21) Appl. No.: 18/418,422

(22) Filed: Jan. 22, 2024

(30) Foreign Application Priority Data
Jan. 26, 2023 (JP) 2023-010095

(51) Int. Cl. H01F 37/00; H01F 27/24; H01F 27/30

(52) U.S. Cl. CPC H01F 37/00; H01F 27/24; H01F 27/306

(57) ABSTRACT

Provided is a reactor that includes a coil, a holding member, and a magnetic core. The coil has a first terminal portion withdrawn from a first end of the coil, and a second terminal portion withdrawn from a second end of the coil. The holding member has a first holding member and a second holding member. Either the first holding member or the second holding member has a first joint portion that is disposed along a part of an outer peripheral surface of the coil and connects between the first body portion and the second body portion. Either the first body portion or the second body portion and the first joint portion include portions of a first coupling structure that are fitted to each other. The first coupling structure includes a first recessed portion and a first protruding portion.

### CROSS-REFERENCE TO RELATED APPLICATIONS

This application claims priority of Japanese Patent Application No. JP2023-010095 filed on Jan. 26, 2023, the contents of which are incorporated herein.

### TECHNICAL FIELD

The present disclosure relates to a reactor, a converter, and a power converter device.

### BACKGROUND

JP 2015-216147A discloses a reactor that includes a coil, a magnetic core, and an end bobbin. The magnetic core has an inner core portion disposed on the inner side of the coil, and an outer core portion disposed on the outer side of the coil. The end bobbin is disposed between an end face of the coil and the outer core portion.

JP 2015-216147A is an example of related art.

### SUMMARY

When the coil is attached to the core, it is desired that the coil is disposed at a predetermined position on the core. The coil is structurally springy. The coil is prone to twisting in production. The coil is prone to deformation due to the springiness or twisting of the coil. The shape of the coil is not stable, making it difficult to attach the coil to the core. A position shift of the coil relative to the core may result in variation in electromagnetic performance of the reactor.

An object of the present disclosure is to provide a reactor that is excellent in the ease of attachment of a coil to a core.

A reactor of the present disclosure includes a coil, a holding member, and a magnetic core on which the coil is disposed, wherein the coil has a first terminal portion withdrawn from a first end of the coil and a second terminal portion withdrawn from a second end of the coil. The first terminal portion is withdrawn from the first end in a direction orthogonal to an axis of the coil. The holding member has a first holding member disposed at the first end and a second holding member disposed at the second end. The first holding member has a first body portion in contact with the first end and a first insertion portion having a through-hole into which the first terminal portion is inserted. The second holding member has a second body portion in contact with the second end. Either the first holding member or the second holding member has a first joint portion that is disposed along a part of an outer peripheral surface of the coil and connects between the first body portion and the second body portion. Either the first body portion or the second body portion and the first joint portion include portions of a first coupling structure that are fitted to each other. The first coupling structure includes a first recessed portion and a first protruding portion.

The reactor of the present disclosure is excellent in the ease of attachment of a coil to a core.

### BRIEF DESCRIPTION OF THE DRAWINGS

FIG. 1 is a schematic plan view of a reactor according to an embodiment.

FIG. 2 is a schematic exploded plan view of the reactor according to the embodiment.

FIG. 3 is a schematic perspective view of a coil included in the reactor according to the embodiment.

FIG. 4 is a schematic perspective view of the coil and a holding member included in the reactor according to the embodiment that are attached to each other.

FIG. 5 is a schematic end view of the holding member included in the reactor according to the embodiment.

FIG. 6 is a schematic right side view of the holding member of the reactor according to the embodiment.

FIG. 7 is a schematic left side view of the holding member included in the reactor according to the embodiment.

FIG. 8 is a schematic bottom view of the holding member included in the reactor according to the embodiment.

FIG. 9 is a schematic perspective view of the coil and the holding member included in the reactor according to a variation that are attached to each other.

FIG. 10 is a schematic right side view of the holding member included in the reactor according to the variation.

FIG. 11 is a schematic left side view of the holding member included in the reactor according to the variation.

FIG. 12 schematically shows a configuration of a power system of a hybrid automobile.

FIG. 13 is a circuit diagram schematically showing a power converter device that includes a converter.

### DETAILED DESCRIPTION OF PREFERRED EMBODIMENTS

Firstly, modes for carrying out the present disclosure will be listed and described.

A In a first aspect, a reactor of the present disclosure includes a coil, a holding member, and a magnetic core on which the coil is disposed. The coil has a first terminal portion withdrawn from a first end of the coil and a second terminal portion withdrawn from a second end of the coil. The first terminal portion is withdrawn from the first end in a direction orthogonal to an axis of the coil. The holding member has a first holding member disposed at the first end and a second holding member disposed at the second end. The first holding member has a first body portion in contact with the first end and a first insertion portion having a through-hole into which the first terminal portion is inserted. The second holding member has a second body portion in contact with the second end. Either the first holding member or the second holding member has a first joint portion that is disposed along a part of an outer peripheral surface of the coil and connects between the first body portion and the second body portion. Either the first body portion or the second body portion and the first joint portion include portions of a first coupling structure that are fitted to each other, and the first coupling structure includes a first recessed portion and a first protruding portion.

With the reactor of the present disclosure, the coil can be more easily attached to the core due to the holding member. According to the reactor of the present disclosure, the first holding member and the second holding member are coupled by the first coupling structure. A position shift between the first body portion and the second body portion is unlikely to occur due to the first holding member and the second holding member being positioned relative to each other. The shape of the coil is stabilized due to the first and second ends of the coil being positioned. The shape of the coil being stabilized makes it easy to attach the coil to the core. As a result of the improvement in the position accuracy of the coil relative to the core, the variation in electromagnetic performance of the reactor can be suppressed. Accordingly, the reactor has improved productivity.

The first holding member is attached to the first end of the coil by sliding the coil in the direction in which the first terminal portion is withdrawn. The first terminal portion is inserted into the through-hole in the first insertion portion by sliding the coil relative to the first holding member. The position of the first terminal portion is restricted by inserting the first terminal portion into the through-hole in the first insertion portion. This improves the position accuracy of the first terminal portion. The operation to connect the first terminal portion to a bus bar can be easily performed.

In a second aspect, in the reactor according to the first aspect, the coil may have a polygonal-tubular shape, the outer peripheral surface of the coil may have a plurality of faces including a first face, the first terminal portion may protrude from the first face as viewed from a direction parallel with the axis of the coil, the second holding member may have the first joint portion disposed along the first face, the first body portion may have the first protruding portion, and the first joint portion may have the first recessed portion.

According to the configuration of the above aspect, when the coil is slid and attached to the first holding member, the first face of the coil is stopped against the first protruding portion provided in the first body portion. The first body portion can be easily disposed at the first end due to the outer peripheral surface of the coil being stopped against the first protruding portion.

In a third aspect, in the reactor according to the second aspect, the second holding member may further have a second joint portion connecting between the first body portion and the second body portion, the second joint portion may be disposed along a second face of the outer peripheral surface, the second face being located on a side opposite to the first face, the first body portion and the second joint portion may include portions of a second coupling structure that are fitted to each other, and the second coupling structure may include a second recessed portion and a second protruding portion.

According to the configuration of the above aspect, the first holding member and the second holding member are coupled by the first coupling structure and the second coupling structure. A position shift between the first body portion and the second body portion is unlikely to occur due to the first holding member and the second holding member being positioned relative to each other by the two coupling structures. The shape of the coil is stabilized more easily.

In a fourth aspect, in the reactor according to the third aspect, the first body portion may have the second protruding portion, the second joint portion may have the second recessed portion, and the second protruding portion may be smaller than the first protruding portion.

According to the configuration of the above aspect, the second protruding portion is unlikely to become an obstacle when the coil is slid and attached to the first holding member. The second face coming into contact with the second protruding portion makes it easy to position the first body portion relative to the first end.

In a fifth aspect, in the reactor according to the first aspect, the coil may have a polygonal-tubular shape, the outer peripheral surface of the coil may have a plurality of faces including a first face, the first terminal portion may protrude from the first face as viewed from a direction parallel with the axis of the coil, and the first holding member may have the first joint portion disposed along the first face.

According to the configuration of the above aspect, when the coil is slid and attached to the first holding member, the first face of the coil is stopped against the first joint portion. The first body portion can be easily disposed at the first end due to the outer peripheral surface of the coil being stopped against the first joint portion.

In a sixth aspect, in the reactor according to any one of aspect one through aspect five, the second terminal portion may be withdrawn from the second end in a direction parallel with the axis of the coil, and the second holding member may have a second insertion portion having a through-hole into which the second terminal portion is inserted.

According to the configuration of the above aspect, the position of the second terminal portion is restricted by inserting the second terminal portion into the through-hole in the second insertion portion. This improves the position accuracy of the second terminal portion. The operation to connect the second terminal portion to a bus bar is facilitated.

In a seventh aspect, a converter of the present disclosure includes the reactor according to any one of aspect one through aspect six.

The converter of the present disclosure, which includes the reactor of the present disclosure, has small variation in electromagnetic performance of the reactor. The converter of the present disclosure has excellent productivity.

In an eighth aspect, a power converter device of the present disclosure includes the converter according to aspect seven.

The power converter device of the present disclosure, which includes the converter of the present disclosure, has excellent productivity.

Specific examples of embodiments of the present disclosure will be described below with reference to the drawings. The same reference numerals in the figures denote the same or corresponding parts.

Note that the present disclosure is not limited to these examples but is described by the claims, and is intended to include all modifications made within the meaning and scope equivalent to the claims.

### Reactor

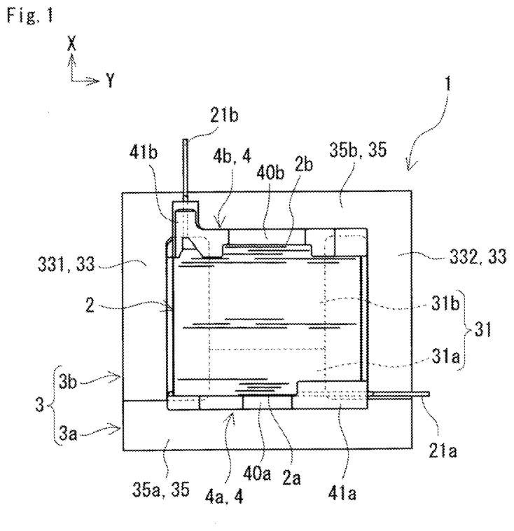

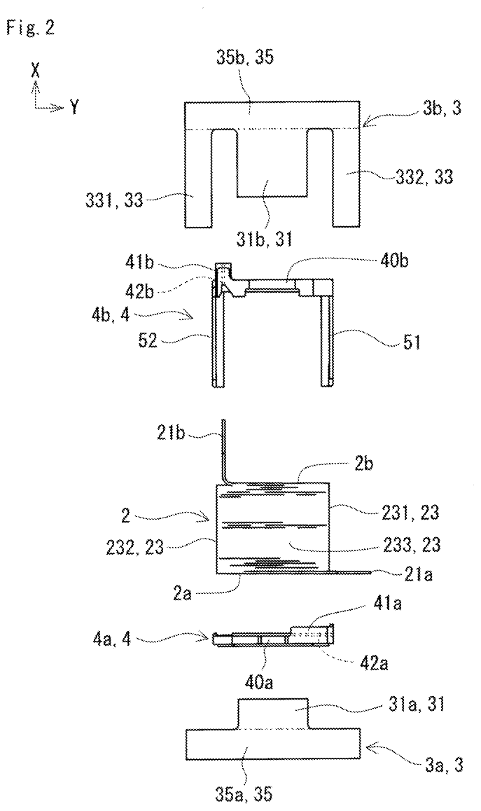

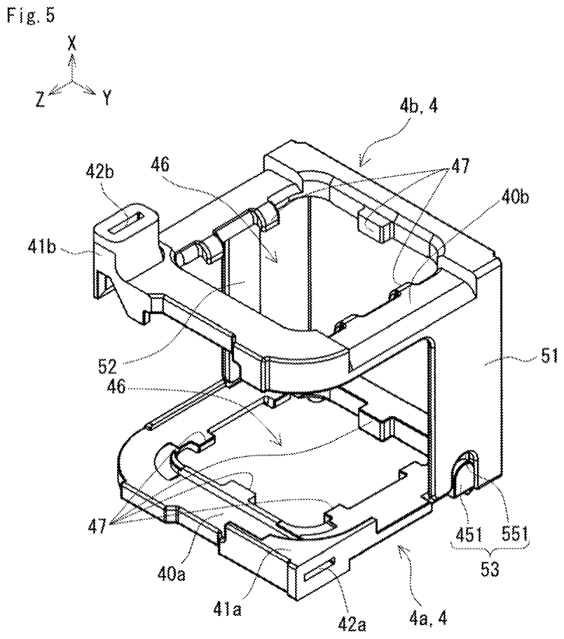

A reactor 1 according to an embodiment is described with reference to FIGS. 1 to 8. As shown in FIGS. 1 and 2, the reactor 1 includes a coil 2, a magnetic core 3, and a holding member 4. The holding member 4 is disposed at two ends of the coil 2. The holding member 4 has a first holding member 4a and a second holding member 4b. One characteristic of the reactor 1 of the embodiment lies in having a structure in which the first holding member 4a and the second holding member 4b are coupled by a first joint portion 51, as shown in FIG. 5. Constituent elements of the reactor 1 will be described in detail below.

### Coil

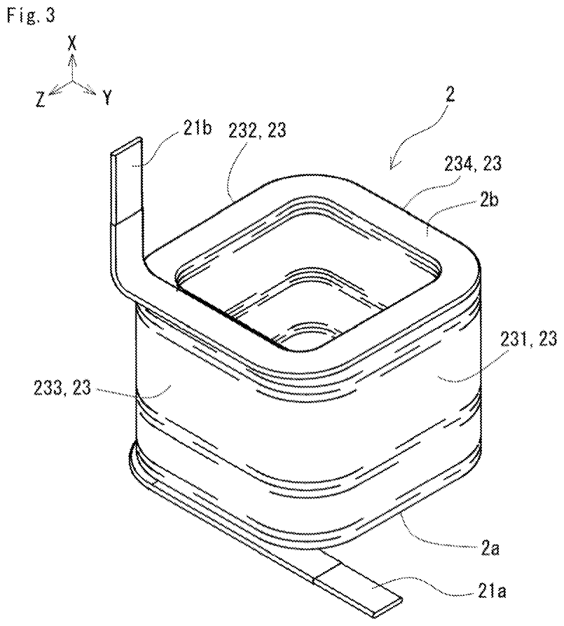

A configuration of the coil 2 is described with reference to FIG. 3. The coil 2 has a tubular shape. The coil 2 has a first end 2a and a second end 2b. The coil 2 in the present embodiment is an edgewise coil constituted by a helically wound flat wire.

The coil 2 may have a polygonal-tubular shape or a cylindrical shape. The “polygonal-tubular shape” refers to the outline shape of an end face of the coil 2 being polygonal. Examples of polygonal shapes include a quadrangular shape, a hexagonal shape, and an octagonal shape. The quadrangular shape includes a rectangular shape. The rectangular shape includes a square shape. For example, a quadrangle is not limited to a geometric quadrangle, but also includes a quadrangle with details changed, such as a shape in which at least one of the four corners is rounded. The cylindrical shape refers to the outline shape of an end face of the coil 2 being circular. The circular shape includes not only a perfect circular shape but also an oval shape. The oval shape includes an elliptic shape.

In the present embodiment, the coil 2 has a polygonal-tubular shape. Specifically, the coil 2 has a rectangular-tubular shape. An outer peripheral surface 23 of the coil 2 has a plurality of faces including a first face 231. Specifically, the outer peripheral surface 23 of the coil 2 has four faces and four corner portions. Each face is flat. Each corner portion has an arc-shaped curved face. The four faces include the first face 231, a second face 232, a third face 233, and a fourth face 234. The first face 231 and the second face 232 are located on opposite sides relative to the central axis of the coil 2. The third face 233 and the fourth face 234 are located on opposite sides relative to the central axis of the coil 2. In the present embodiment, the direction in which the first face 231 is oriented is the rightward direction. The direction in which the second face 232 is oriented is the leftward direction. The direction in which the third face 233 is oriented is the upward direction. The direction in which the fourth face 234 is oriented is the downward direction.

The coil 2 has a first terminal portion 21a and a second terminal portion 21b. The first terminal portion 21a is withdrawn from the first end 2a. The second terminal portion 21b is withdrawn from the second end 2b. In the present embodiment, the first terminal portion 21a is withdrawn from the first end 2a in a Y-axis direction, which is orthogonal to the axis of the coil 2. The second terminal portion 21b is withdrawn from the second end 2b in an X-axis direction, which is parallel with the axis of the coil 2. In the present embodiment, the X-axis direction, the Y-axis direction, and the Z-axis direction are defined as follows. The X-axis direction is a direction parallel with the axis of the coil 2, and is a direction from the first end 2a toward the second end 2b. The Y-axis direction is a direction orthogonal to the X-axis direction, and is a direction from the second face 232 toward the first face 231. The Y-axis direction is the rightward direction. The Z-axis direction is a direction orthogonal to the X-axis direction and the Y-axis direction, and is a direction from the fourth face 234 toward the third face 233. The Z-axis direction is the upward direction.

The first terminal portion 21a in the present embodiment protrudes from the first face 231 as viewed from a direction parallel with the axis of the coil 2. The first terminal portion 21a protrudes in a direction orthogonal to the first face 231. Specifically, the first terminal portion 21a protrudes in the Y-axis direction. That is, the first terminal portion 21a extends substantially along a plane obtained by extending an end face of the first end 2a in the Y-axis direction. The position at which the first terminal portion 21a is withdrawn is a corner portion of the first end 2a between the first face 231 and the third face 233. The second terminal portion 21b protrudes from an end face of the second end 2b. The second terminal portion 21b extends in a direction orthogonal to the end face of the second end 2b. The position at which the second terminal portion 21b is withdrawn is a corner portion of the second end 2b between the second face 232 and the third face 233.

A bus bar (not shown) is connected to the first terminal portion 21a and the second terminal portion 21b. The terminal portions and the bus bar are connected by means of welding, for example. The bus bar is a member that electrically connects the coil 2 to an external device (not shown).

### Magnetic Core

A configuration of the magnetic core 3 is described with reference to FIGS. 1 and 2. The coil 2 is disposed in the magnetic core 3. The magnetic core 3 in the present embodiment has a middle core portion 31, side core portions 33, and end core portions 35. As shown in FIG. 1, the magnetic core 3 has a 0 shape in a plan view.

The magnetic core 3 forms a θ-shaped closed magnetic path. When a current flows through the coil 2, a magnetic flux flows through the magnetic core 3. The magnetic flux generated by the coil 2 flows from the middle core portion 31, via the end core portions 35 and the side core portions 33, and back to the middle core portion 31.

### Middle Core Portion

As shown in FIG. 1, the middle core portion 31 is a portion disposed within the coil 2. One middle core portion 31 is provided. Two end portions of the middle core portion 31 may protrude from respective ends of the coil 2. These protruding portions are also included in the middle core portion 31. In the present embodiment, the middle core portion 31 has a substantially rectangular-parallelepiped shape.

The middle core portion 31 is disposed between a first end core portion 35a and a second end core portion 35b. The first end core portion 35a and the second end core portion 35b will be described later. A first end portion of the middle core portion 31 is coupled to the first end core portion 35a. A second end portion of the middle core portion 31 is coupled to the second end core portion 35b.

The middle core portion 31 in the present embodiment has a first middle core portion 31a and a second middle core portion 31b. The first middle core portion 31a and the second middle core portion 31b are arranged in series in a direction along the length of the middle core portion 31. The direction along the length of the middle core portion 31 coincides with a direction parallel with the axis of the coil 2, i.e. the X-axis direction. The first middle core portion 31a is coupled to a first end core portion 35a. The second middle core portion 31b is coupled to a second end core portion 35b. The boundary between the first middle core portion 31a and the second middle core portion 31b is located within the coil 2. The lengths of the first middle core portion 31a and the second middle core portion 31b can be set as appropriate. The length of the first middle core portion 31a and the length of the second middle core portion 31b may be the same or different.

The middle core portion 31 may also have a gap portion between the first middle core portion 31a and the second middle core portion 31b. The middle core portion 31 having the gap portion enables adjustment of the inductance of the reactor 1. The gap portion is located within the coil 2. The gap portion may be an air gap. The gap portion may be constituted by a non-magnetic material made of resin or ceramics, for example. In the case where the gap portion is not provided, the first middle core portion 31a and the second middle core portion 31b are in contact with each other, and there is substantially no space between the first middle core portion 31a and the second middle core portion 31b.

### Side Core Portion

As shown in FIG. 1, the side core portions 33 are disposed outside the coil 2. The side core portions 33 are disposed on respective sides of the coil 2. Two side core portions 33 are provided. The side core portions 33 include a first side core portion 331 and a second side core portion 332. The first side core portion 331 and the second side core portion 332 are spaced from each other in the Y-axis direction.

The side core portions 33 are parallel with the middle core portion 31. A first end portion of each side core portion 33 is coupled to a later-described first end core portion 35a. A second end portion of each side core portion 33 is coupled to a later-described second end core portion 35b.

### End Core Portion

As shown in FIG. 1, the end core portions 35 are disposed outside the coil 2. The end core portions 35 face the respective ends of the coil 2. Two end core portions 35 are provided. The end core portions 35 include a first end core portion 35a and a second end core portion 35b. The first end core portion 35a faces the first end 2a of the coil 2. The second end core portion 35b faces the second end 2b of the coil 2. The first end core portion 35a and the second end core portion 35b are spaced from each other in the X-axis direction.

### First Core and Second Core

The magnetic core 3 in the present embodiment has a first core 3a and a second core 3b, as shown in FIG. 2. The first core 3a and the second core 3b are combined to form the magnetic core 3. The shapes of the first core 3a and the second core 3b can be selected from various combinations. In the present embodiment, the first core 3a has a T-shape, and the second core 3b has an E-shape. That is, the magnetic core 3 is an ET core that is a combination of an E-shaped core and a T-shaped core. The magnetic core 3 may be, for example, any of an EE core, an EI core, and a UT core. The EE core has a structure in which E-shaped cores are combined. The EI core has a structure in which an E-shaped core and an I-shaped core are combined. The UT core has a structure in which a U-shaped core and a T-shaped core are combined.

The first core 3a in the present embodiment has the first end core portion 35a and the first middle core portion 31a. The first end core portion 35a and the first middle core portion 31a are integrally molded. The first core 3a is a one-piece molded product. The first core 3a has a T-shape in a plan view. In FIG. 2, the boundary between the first end core portion 35a and the middle core portion 31 is indicated by a double-dashed line.

The second core 3b in the present embodiment has the second end core portion 35b, the second middle core portion 31b, the first side core portion 331, and the second side core portion 332. The second end core portion 35b, the second middle core portion 31b, the first side core portion 331, and the second side core portion 332 are integrally molded. The second core 3b is a one-piece molded product. The second core 3b has an E-shape in a plan view. In FIG. 2, the boundary between the second end core portion 35b and the middle core portion 31 and the boundaries between the second end core portion 35b and the side core portions 33 are indicated by double-dashed lines.

The first core 3a and the second core 3b are each constituted by a molded body made of a soft magnetic material. The molded body is, for example, a powder compact or a molded body made of a composite material.

The powder compact is made by compressing and molding raw material powder containing the soft magnetic powder. The powder compact has a higher content of the soft magnetic powder than the molded body made of a composite material. The powder compact has, therefore, higher magnetic properties than the molded body made of a composite material. The magnetic properties include, for example, relative permeability and saturation magnetic flux density. The powder compact may contain, for example, either a binder resin or a molding aid. The content of the soft magnetic powder in the powder compact is, for example, 85 volume % or more and 99.99 volume % or less when the powder compact is 100 volume %.

The molded body of a composite material includes soft magnetic powder dispersed in resin. The molded body of a composite material is obtained by filling a mold with a fluid material in which the soft magnetic powder is dispersed in unsolidified resin, and then solidifying the resin. The content of the soft magnetic powder in the molded body of a composite material can be easily adjusted. Therefore, the magnetic properties of the molded body of a composite material can be easily adjusted. The content of the soft magnetic powder in the molded body of a composite material is, for example, 20 volume % or more and 80 volume % or less when the molded body of a composite material is 100 volume %.

Particles constituting the soft magnetic powder are of at least one type selected from a group consisting of soft magnetic metal particles, coated particles having an insulating coating on the outer periphery of each soft magnetic metal particle, and soft magnetic non-metal particles. The soft magnetic metal is, for example, pure iron or an iron-based alloy. The iron-based alloy is, for example, a Fe (iron)-Si (silicon) alloy or a Fe—Ni (nickel) alloy. The insulating coating is, for example, phosphate. The soft magnetic non-metal is, for example, ferrite.

The first core 3a and the second core 3b may be made of the same material or different materials. In the present embodiment, the first core 3a is made of a molded body of a composite material, and the second core 3b is made of a powder compact.

### Holding Member

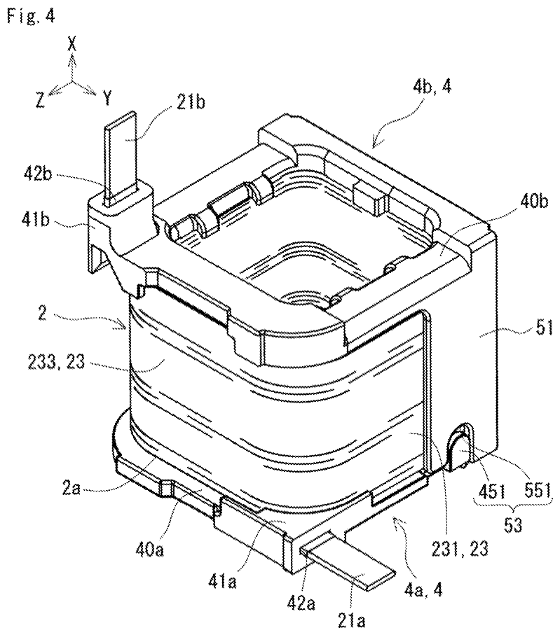

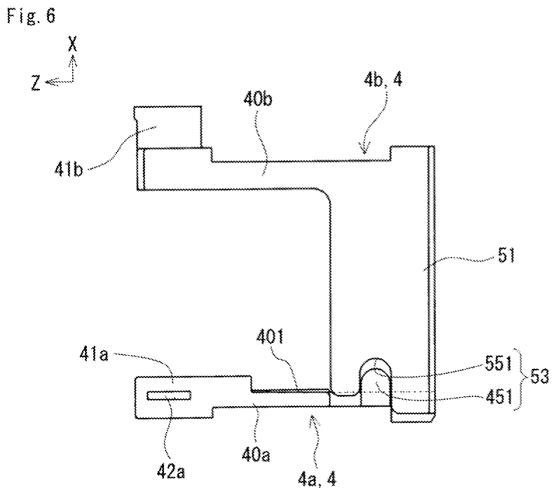

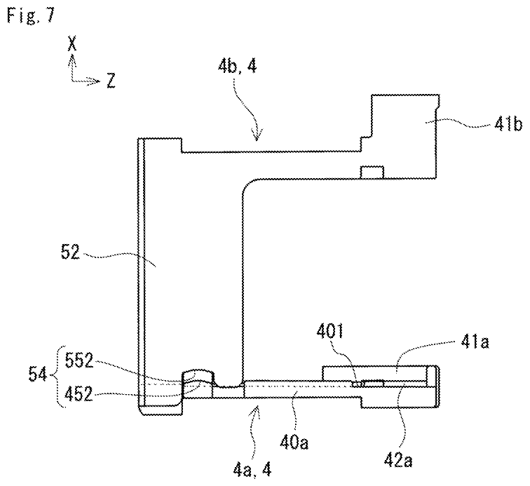

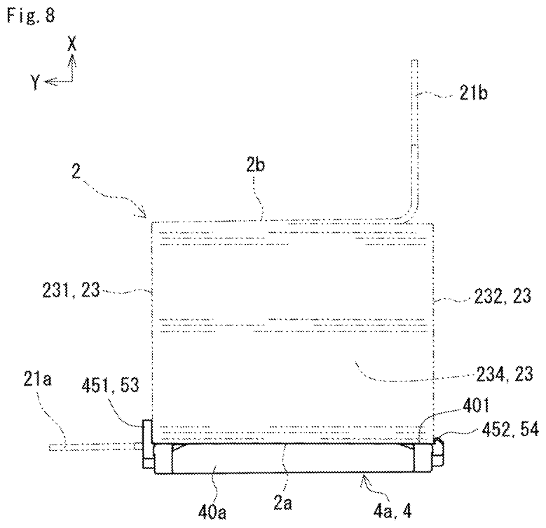

A configuration of the holding member 4 is described with reference to FIGS. 4 to 8. The following description references FIGS. 2 and 3 as necessary for the configuration of the coil 2. The following description references FIGS. 1 and 2 as necessary for the configuration of the magnetic core 3. There are cases where the coil 2 with the holding member 4 attached is referred to as a “coil assembly”. FIG. 6 shows the holding member 4 as viewed from the right. FIG. 7 shows the holding member 4 as viewed from the left. FIG. 8 shows the holding member 4 as viewed from below. The holding member 4 positions the coil 2 relative to the magnetic core 3 and ensures electrical insulation between the coil 2 and the magnetic core 3. The holding member 4 is made of resin. As shown in FIGS. 4 and 5, the holding member 4 has a first holding member 4a and a second holding member 4b. The first holding member 4a and the second holding member 4b are components independent of each other. Either the first holding member 4a or the second holding member 4b has a first joint portion 51. The first joint portion 51 will be described later.

### First Holding Member

The first holding member 4a is a component disposed at the first end 2a of the coil 2 shown in FIG. 2. The first holding member 4a has a first body portion 40a and a first insertion portion 41a, as shown in FIGS. 4 and 5. The first body portion 40a is a portion that comes into contact with the first end 2a. The first insertion portion 41a is a portion into which the first terminal portion 21a is inserted. The first body portion 40a and the first insertion portion 41a are integrally molded.

### First Body Portion

The first body portion 40a is disposed between the first end 2a and the first end core portion 35a. The first body portion 40a ensures electrical insulation between the coil 2 and the first end core portion 35a. As shown in FIG. 5, the first body portion 40a has a frame shape corresponding to the end face of the first end 2a. The first body portion 40a in the present embodiment has a rectangular frame shape.

The face of the first body portion 40a that comes into contact with the end face of the first end 2a is an inclined face extending along the helix of the coil 2. That is, the thickness of the four sides constituting the first body portion 40a gradually increases along the circumferential direction of the first body portion 40a.

The first body portion 40a has an opening 46. The first end portion of the middle core portion 31 is disposed in the opening 46 in the state where the middle core portion 31 is disposed within the coil 2 as shown in FIG. 1. The shape of the opening 46 roughly corresponds to the cross section of the first middle core portion 31a. The opening 46 in the present embodiment has a substantially rectangular shape.

Further, the first body portion 40a has a plurality of protrusions 47 that protrude into the opening 46. Each protrusion 47 protrudes from the inner peripheral surface of the first body portion 40a, which constitutes the opening 46. Each protrusion 47 protrudes inward of the inner peripheral surface of the coil 2 with the first holding member 4a attached to the coil 2. Each protrusion 47 comes into contact with the outer peripheral surface of the first end portion of the middle core portion 31 with the middle core portion 31 disposed within the coil 2. With this configuration, a gap is formed between the inner peripheral surface of the coil 2 and the outer peripheral surface of the middle core portion 31. This gap ensures electrical insulation between the coil 2 and the middle core portion 31. In the present embodiment, of the four sides constituting the first body portion 40a, sides facing each other in the Z-axis direction each have one protrusion 47, and sides facing each other in the Y-axis direction each have two protrusions 47. The protrusions 47 on the sides facing each other in the Z-axis direction have the same size and shape. The protrusions 47 on the sides facing each other in the Y-axis direction have the same size and shape. The shape of the protrusions 47 on the sides facing each other in the Z-axis direction is different from the shape of the protrusions 47 on the sides facing each other in the Y-axis direction. The shapes, number and positions of the protrusions 47 of the first body portion 40a may be changed as appropriate.

When the first holding member 4a is attached to the coil 2, the first body portion 40a is positioned relative to the first end 2a, as shown in FIG. 4.

### First Insertion Portion

The first insertion portion 41a has a through-hole 42a into which the first terminal portion 21a is inserted, as shown in FIG. 4. The first insertion portion 41a is provided at a position at which the first terminal portion 21a is withdrawn. The first insertion portion 41a in the present embodiment is provided at a position corresponding to a corner between the first face 231 and the third face 233 at the first end 2a of the coil 2 shown in FIG. 3. In the first body portion 40a, the area where the first insertion portion 41a is provided is locally thicker.

The through-hole 42a extends through the first insertion portion 41a in a direction orthogonal to the axis of the coil 2. Specifically, the through-hole 42a extends through the first insertion portion 41a in a direction in which the first terminal portion 21a is withdrawn. The through-hole 42a is open in a face of the first insertion portion 41a that corresponds to the first face 231 from which the first terminal portion 21a protrudes. The shape of the opening of the through-hole 42a is a shape corresponding to the cross section of the first terminal portion 21a. The through-hole 42a in the present embodiment is a flat rectangular hole that corresponds to the shape of the flat wire constituting the coil 2. The position of the first terminal portion 21a is restricted by inserting the first terminal portion 21a into the through-hole 42a. The leading end of the first terminal portion 21a protruding from the first insertion portion 41a is restrained from shifting in a direction parallel with the axis of the coil 2, i.e. the X-axis direction, relative to the first insertion portion 41a. This improves the position accuracy of the first terminal portion 21a.

### Second Holding Member

The second holding member 4b is a component disposed at the second end 2b of the coil 2 shown in FIG. 2. As shown in FIGS. 4 and 5, the second holding member 4b has a second body portion 40b. The second body portion 40b is a portion that comes into contact with the second end 2b. The second holding member 4b in the present embodiment also has a second insertion portion 41b. The second insertion portion 41b is a portion into which the second terminal portion 21b is inserted. The second body portion 40b and the second insertion portion 41b are integrally molded.

### Second Body Portion

The second body portion 40b is disposed between the second end 2b and the second end core portion 35b. The second body portion 40b ensures electrical insulation between the coil 2 and the second end core portion 35b. As shown in FIG. 5, the second body portion 40b has a frame shape corresponding to the end face of the second end 2b. The second body portion 40b in the present embodiment has a rectangular frame shape.

The face of the second body portion 40b that comes into contact with the end face of the second end 2b is an inclined face extending along the helix of the coil 2. That is, the thickness of the four sides constituting the second body portion 40b gradually increases along the circumferential direction of the second body portion 40b.

The second body portion 40b has an opening 46. The second end portion of the middle core portion 31 is disposed in the opening 46 in the state where the middle core portion 31 is disposed within the coil 2 as shown in FIG. 1. The shape of the opening 46 roughly corresponds to the cross section of the second middle core portion 31b. The opening 46 in the present embodiment has a substantially rectangular shape.

Further, the second body portion 40b has a plurality of protrusions 47 that protrude into the opening 46. Each protrusion 47 protrudes from the inner peripheral surface of the second body portion 40b, which constitutes the opening 46. Each protrusion 47 protrudes inward of the inner peripheral surface of the coil 2 with the second holding member 4b attached to the coil 2. Each protrusion 47 comes into contact with the outer peripheral surface of the second end portion of the middle core portion 31 with the middle core portion 31 disposed within the coil 2. With this configuration, a gap is formed between the inner peripheral surface of the coil 2 and the outer peripheral surface of the middle core portion 31. This gap ensures electrical insulation between the coil 2 and the middle core portion 31. In the present embodiment, of the four sides constituting the second body portion 40b, sides facing each other in the Z-axis direction each have one protrusion 47, and sides facing each other in the Y-axis direction each have two protrusions 47, as in the first body portion 40a. The shapes, number and positions of the protrusions 47 of the second body portion 40b may be changed as appropriate.

When the second holding member 4b is attached to the coil 2, the second body portion 40b is positioned relative to the second end 2b, as shown in FIG. 4.

### Second Insertion Portion

The second insertion portion 41b has a through-hole 42b into which the second terminal portion 21b is inserted, as shown in FIG. 4. The second insertion portion 41b is provided at a position at which the second terminal portion 21b is withdrawn. The second insertion portion 41b in the present embodiment is provided at a position corresponding to a corner between the second face 232 and the third face 233 at the second end 2b of the coil 2 shown in FIG. 3.

The through-hole 42b extends through the second insertion portion 41b in a direction parallel with the axis of the coil 2. The shape of the opening of the through-hole 42b is a shape corresponding to the cross section of the second terminal portion 21b. Similar to the through-hole 42a, the through-hole 42b in the present embodiment is a flat rectangular hole that corresponds to the shape of the flat wire. The position of the second terminal portion 21b is restricted by inserting the second terminal portion 21b into the through-hole 42b. The leading end of the second terminal portion 21b protruding from the second insertion portion 41b is restrained from shifting in a direction orthogonal to the axis of the coil 2, i.e. the Y-axis direction, relative to the second insertion portion 41b. This improves the position accuracy of the second terminal portion 21b.

### First Joint Portion

The first joint portion 51 is described with reference to FIGS. 4 to 6. The first joint portion 51 is disposed along a part of the outer peripheral surface 23 of the coil 2 shown in FIG. 3. The first joint portion 51 connects between the first body portion 40a and the second body portion 40b. Either the first body portion 40a or the second body portion 40b and the first joint portion 51 include portions of a first coupling structure 53 that are fitted to each other. The first coupling structure 53 couples the first holding member 4a and the second holding member 4b to each other. In the present embodiment, the second holding member 4b has the first joint portion 51. The first coupling structure 53 couples the first body portion 40a to the first joint portion 51.

In the present embodiment, the first joint portion 51 is disposed along the first face 231, of the outer peripheral surface 23 of the coil 2. The first joint portion 51 has a plate shape. The first joint portion 51 covers a part of the first face 231. The first joint portion 51 extends from the second body portion 40b to the first body portion 40a. The first joint portion 51 is integrally molded with the second body portion 40b. A leading end portion of the first joint portion 51 overlaps an outer peripheral surface of the first body portion 40a. Unlike the present embodiment, the first joint portion 51 may alternatively be disposed along either the third face 233 or the fourth face 234.

### First Coupling Structure

As shown in FIG. 6, the first coupling structure 53 includes a first recessed portion 551 and a first protruding portion 451, which are fitted to each other. In the present embodiment, the first joint portion 51 has the first recessed portion 551, and the first body portion 40a has the first protruding portion 451. The first recessed portion 551 is provided at the leading end portion of the first joint portion 51. The first protruding portion 451 is provided at a position corresponding to the first recessed portion 551 in the outer peripheral surface of the first body portion 40a. In the present embodiment, the first protruding portion 451 is provided in a face that is the same as the face in which the through-hole 42a is open. The through-hole 42a and the first protruding portion 451 are provided on respective sides of one of the four sides constituting the first body portion 40a. The first protruding portion 451 protrudes from the first body portion 40a towards the second body portion 40b. The first protruding portion 451 protrudes in a direction parallel with the axis of the coil 2, i.e. the X-axis direction. Unlike the present embodiment, the first protruding portion 451 may alternatively protrude only in the Y-axis direction from the outer peripheral surface of the first body portion 40a, without protruding in the X-axis direction. Unlike the present embodiment, the first joint portion 51 may have the first protruding portion, and the first body portion 40a may have the first recessed portion. In the case where the first joint portion 51 has the first protruding portion, the first protruding portion protrudes from the leading end portion of the first joint portion 51 toward the first body portion 40a.

The first holding member 4a and the second holding member 4b are positioned relative to each other by fitting the first recessed portion 551 and the first protruding portion 451 to each other. The first protruding portion 451 need not be inserted deep into the first recessed portion 551. That is, a leading end of the first protruding portion 451 need not be in contact with the first recessed portion 551, and a clearance may be formed between the leading end of the first protruding portion 451 and the first recessed portion 551.

The first coupling structure 53 may alternatively be a snap-fit structure, instead of having a configuration in which the first recessed portion 551 is simply fitted into the first protruding portion 451 as in the present embodiment. Although not shown in the figures, in the case of a snap-fit structure, the first protruding portion is provided overlapping an outer face of the first joint portion 51. The first recessed portion is provided in the outer face of the first joint portion 51. The outer face of the first joint portion 51 is a face on the side opposite to the inner face facing the outer peripheral surface 23 of the coil 2 shown in FIG. 4. The first protruding portion has a claw to be fitted to the first recessed portion. This claw is provided at a leading end portion of the first protruding portion. The first protruding portion is hooked to the first recessed portion as a result of the claw of the first protruding portion being fitted into the first recessed portion. The first recessed portion is a through-hole or a stop hole into which the claw is fitted.

The first coupling structure 53 couples the first holding member 4a and the second holding member 4b to each other. A position shift between the first body portion 40a and the second body portion 40b is unlikely to occur due to the first holding member 4a and the second holding member 4b being positioned relative to each other. The shape of the coil 2 is stabilized due to the first end 2a and the second end 2b of the coil 2 being positioned.

### Second Joint Portion

The second holding member 4b in the present embodiment also has a second joint portion 52. The second joint portion 52 is described with reference to FIGS. 4, 5, and 7. The second joint portion 52 connects between the first body portion 40a and the second body portion 40b. As shown in FIG. 7, the first body portion 40a and the second joint portion 52 include portions of a second coupling structure 54 that are fitted to each other. The second coupling structure 54 couples the first body portion 40a to the second joint portion 52.

The second joint portion 52 is disposed on the face different from the face where the first joint portion 51 is disposed, of the outer peripheral surface 23 of the coil 2. In the present embodiment, the second joint portion 52 is disposed along the second face 232. The second joint portion 52 has a plate shape. The second joint portion 52 covers a part of the second face 232. The second joint portion 52 extends from the second body portion 40b to the first body portion 40a. The second joint portion 52 is integrally molded with the second body portion 40b. A leading end portion of the second joint portion 52 overlaps the outer peripheral surface of the first body portion 40a. Unlike the present embodiment, the second joint portion 52 may alternatively be disposed along either the third face 233 or the fourth face 234.

### Second Coupling Structure

As shown in FIG. 7, the second coupling structure 54 includes a second recessed portion 552 and a second protruding portion 452, which are fitted to each other. In the present embodiment, the second joint portion 52 has the second recessed portion 552, and the first body portion 40a has the second protruding portion 452. The second recessed portion 552 is provided at the leading end portion of the second joint portion 52. The second protruding portion 452 is provided at a position corresponding to the second recessed portion 552 in the outer peripheral surface of the first body portion 40a. The second protruding portion 452 protrudes from the first body portion 40a towards the second body portion 40b. The second protruding portion 452 protrudes in a direction parallel with the axis of the coil 2, i.e. the X-axis direction. The second protruding portion 452 may alternatively protrude only in a direction opposite to the Y-axis direction from the outer peripheral surface of the first body portion 40a, without protruding in the X-axis direction, as in the above-described first coupling structure 53. Unlike the present embodiment, the second joint portion 52 may have the second protruding portion, and the first body portion 40a may have the second recessed portion.

The first holding member 4a and the second holding member 4b are positioned relative to each other by fitting the second recessed portion 552 and the second protruding portion 452 to each other. The second protruding portion 452 need not be inserted deep into the second recessed portion 552. That is, the leading end of the second protruding portion 452 need not be in contact with the second recessed portion 552, and a clearance may be formed between the leading end of the second protruding portion 452 and the second recessed portion 552.

Similar to the above-described first coupling structure 53, the second coupling structure 54 may be a snap-fit structure. Although not shown in the figures, in the case of a snap-fit structure, the second protruding portion is provided overlapping an outer face of the second joint portion 52. The second recessed portion is provided in the outer face of the second joint portion 52. The outer face of the second joint portion 52 is a face on the side opposite to the inner face facing the outer peripheral surface 23 of the coil 2 shown in FIG. 4. The second protruding portion has a claw to be fitted to the second recessed portion. This claw is provided at the leading end portion of the second protruding portion. The second protruding portion is hooked to the second recessed portion as a result of the claw of the second protruding portion being fitted into the second recessed portion. The second recessed portion is a through-hole or a stop hole into which the claw is fitted.

In the present embodiment, the first coupling structure 53 and the second coupling structure 54 couple the first holding member 4a and the second holding member 4b to each other. A position shift between the first body portion 40a and the second body portion 40b is unlikely to occur due to the first holding member 4a and the second holding member 4b being positioned relative to each other by the two coupling structures. The shape of the coil 2 is stabilized more easily.

In the present embodiment, the first body portion 40a has the first protruding portion 451 and the second protruding portion 452. As shown in FIG. 8, the second protruding portion 452 is smaller than the first protruding portion 451. Specifically, the protrusion length of the second protruding portion 452 is smaller than the protrusion length of the first protruding portion 451. The “protrusion length” refers to the dimension in the X-axis direction. Specifically, the protrusion length of each of the first protruding portion 451 and the second protruding portion 452 refers to the distance from a face 401 of the first body portion 40a that is in contact with the end face of the first end 2a to the leading end of the corresponding protruding portion.

### Method for Attaching Holding Member

A coil assembly shown in FIG. 4 is obtained by attaching the holding member 4 to the coil 2. A method for attaching the holding member 4 to the coil 2 is described. The holding member 4 is attached to the coil 2 by attaching the first holding member 4a to the coil 2 and thereafter attaching the second holding member 4b to the coil 2.

A method for attaching the first holding member 4a to the coil 2 is described. The first body portion 40a is slid along the end face of the first end 2a such that the first terminal portion 21a is inserted into the through-hole 42a. That is, the coil 2 is slid in the direction in which the first terminal portion 21a protrudes relative to the first holding member 4a. The first holding member 4a can thus be attached to the first end 2a. In the present embodiment, the coil 2 slides in the Y-axis direction.

A method for attaching the second holding member 4b to the coil 2 is described. The second holding member 4b is moved in a direction parallel with the axis of the coil 2 such that the second terminal portion 21b is inserted into the through-hole 42b. The second holding member 4b can thus be attached to the second end 2b. When the second holding member 4b is attached to the coil 2, the first protruding portion 451 and the second protruding portion 452 are fitted into the first recessed portion 551 and the second recessed portion 552, respectively.

In the present embodiment, when the coil 2 is slid and attached to the first holding member 4a, the outer peripheral surface 23 of the coil 2 is stopped against the first protruding portion 451 provided on the first body portion 40a. Specifically, the first face 231 is stopped against the first protruding portion 451. The first body portion 40a can be easily disposed at the first end 2a due to the outer peripheral surface 23 of the coil 2 being stopped against the first protruding portion 451. Further, in the present embodiment, the first body portion 40a can be easily positioned relative to the first end 2a due to the second face 232 coming into contact with the second protruding portion 452.

Unlike the present embodiment, the first holding member 4a may have the first joint portion 51. In the case where the first holding member 4a has the first joint portion 51, the first face 231 is stopped against the first joint portion 51.

In the present embodiment, the second protruding portion 452 is smaller than the first protruding portion 451, as shown in FIG. 8 described above. Thus, the second protruding portion 452 is unlikely to become an obstacle when the coil 2 is slid and attached to the first holding member 4a. The protrusion length of the second protruding portion 452 is large enough not to obstruct the slide of the coil 2.

### Resin Mold Member

The reactor 1 may also include a resin mold member (not shown). The resin mold member covers at least a part of the outer peripheral surface of the magnetic core 3. The resin mold member integrates the first core 3a with the second core 3b. The resin mold member also integrates the coil 2 with the magnetic core 3. The resin mold member is formed in the state where the coil 2 is positioned relative to the magnetic core 3 by the holding member 4. The resin mold member may also cover the outer peripheral surface 23 of the coil 2. The resin mold member may be formed such that either the third face 233 or the fourth face 234 of the coil 2 is exposed.

### Method for Attaching Reactor

The reactor 1 is produced by attaching the above-described coil assembly to the magnetic core 3. An example of a method for attaching the reactor is described. The first core 3a is disposed such that the first middle core portion 31a is inserted into the coil 2, and the second core 3b is disposed such that the second middle core portion 31b is inserted into the coil 2. As a result, the coil 2 is attached to the magnetic core 3. The first end portion and the second end portion of the middle core portion 31 are respectively inserted into the opening 46 in the first body portion 40a of the first holding member 4a and the opening 46 in the second body portion 40b of the second holding member 4b. After attaching the coil 2 to the magnetic core 3, the coil 2 and the magnetic core 3 may be integrated by the aforementioned resin mold member. The resin mold member is molded by disposing an assembly of the coil 2 and the magnetic core 3 in a mold and then filling the mold with resin. The resin mold member can be molded by means of injection molding, for example. Gaps formed on both sides of each protrusion 47 of the first body portion 40a and the second body portion 40b function as inlets for introducing the resin into space between the coil 2 and the middle core portion 31 when molding the resin mold member.

In the present embodiment, the shape of the coil 2 is stabilized, as mentioned above, by attaching the holding member 4 to the coil 2. The coil 2 can be easily attached to the magnetic core 3 as a result of the shape of the coil 2 being stable. As a result of the improvement in the position accuracy of the coil 2 relative to the magnetic core 3, variation in electromagnetic performance of the reactor 1 can be suppressed. Accordingly, the reactor 1 has improved productivity. The position of each terminal portions is restricted, as mentioned above, by inserting the first terminal portion 21a and the second terminal portion 21b into the through-hole 42a in the first insertion portion 41a and the through-hole 42b in the second insertion portion 41b, respectively. The improvement in position accuracy of the first terminal portion 21a and the second terminal portion 21b improves the operability in connection between each terminal portion and a bus bar.

### Variations

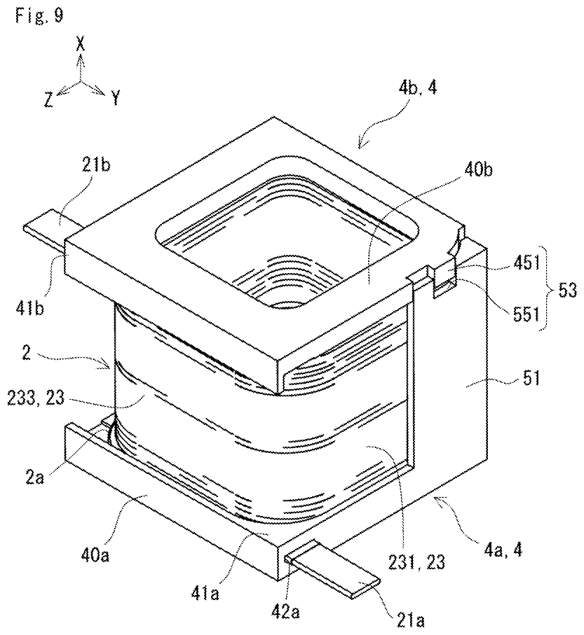

A variation of the above embodiment is described with reference to FIGS. 9 to 11. As shown in FIG. 9, in the variation, the direction in which the second terminal portion 21b is withdrawn is different from that of the coil 2 described in the embodiment. In addition, the configuration of the first holding member 4a and the second holding member 4b is different from that of the holding member 4 described in the embodiment. The following description focuses on differences from the embodiment. Configurations similar to those of the embodiment are assigned the same reference numerals and description thereof is omitted.

The second terminal portion 21b is withdrawn in a direction orthogonal to the axis of the coil 2. The second terminal portion 21b protrudes from the second face 232 shown in FIG. 3, as viewed from a direction parallel with the axis of the coil 2. The direction in which the second terminal portion 21b is withdrawn is opposite to the direction in which the first terminal portion 21a is withdrawn.

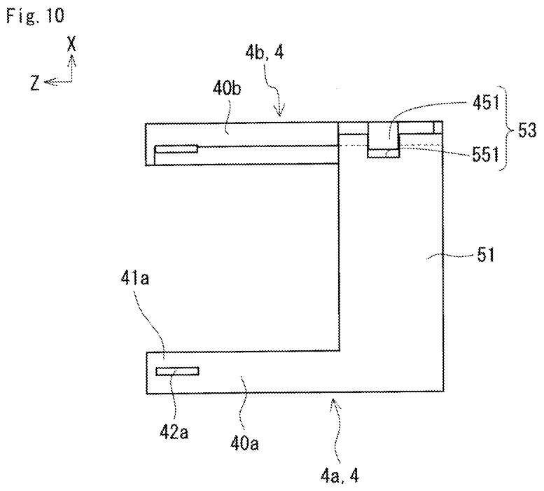

As shown in FIGS. 9 and 10, the first holding member 4a in the variation has a first joint portion 51 disposed along the first face 231. The first joint portion 51 extends from the first body portion 40a to the second body portion 40b. The first joint portion 51 is integrally molded with the first body portion 40a. A leading end portion of the first joint portion 51 overlaps an outer peripheral surface of the second body portion 40b. The first coupling structure 53 couples the second body portion 40b to the first joint portion 51. The first joint portion 51 has the first recessed portion 551, and the second body portion 40b has the first protruding portion 451. The first protruding portion 451 protrudes from the second body portion 40b towards the first body portion 40a.

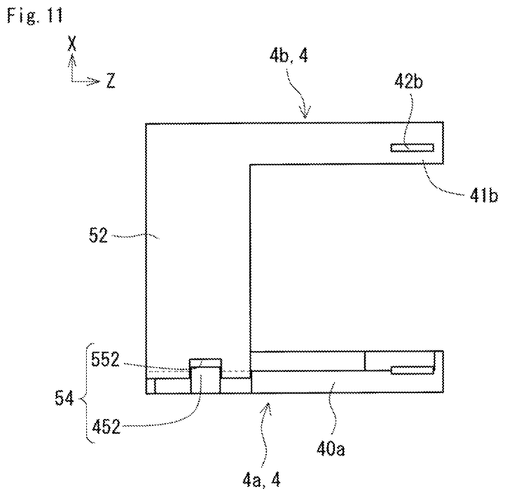

As shown in FIG. 11, the second holding member 4b in the variation has a second joint portion 52 disposed along the second face 232 shown in FIG. 3. The second coupling structure 54 couples the first body portion 40a to the second joint portion 52. The second joint portion 52 has the second recessed portion 552, and the first body portion 40a has the second protruding portion 452.

The second insertion portion 41b of the second holding member 4b has a through-hole 42b into which the second terminal portion 21b is inserted. The second insertion portion 41b is provided at a position at which the second terminal portion 21b shown in FIG. 9 is withdrawn. The through-hole 42b extends through the second insertion portion 41b in a direction in which the second terminal portion 21b is withdrawn. The through-hole 42b is open in a face of the second insertion portion 41b that corresponds to the second face 232 from which the second terminal portion 21b protrudes.

The holding member 4 is attached to the coil 2 as follows, for example. The first holding member 4a is attached to the first end 2a by sliding the coil 2 in the direction in which the first terminal portion 21a protrudes. Next, the second holding member 4b is attached to the second end 2b by sliding the coil 2 in the direction in which the second terminal portion 21b protrudes. The sliding direction of the coil 2 when attaching the second holding member 4b is a direction opposite to the sliding direction of the coil 2 when attaching the first holding member 4a. Either the first holding member 4a or the second holding member 4b may be attached first.

### Converter and Power Converter Device

The reactor 1 of the embodiment can be used in applications that satisfy the following current-flow conditions. For example, the current-flow conditions are that the maximum direct current is about 100 A or more and 1000 A or less, the average voltage is about 100 V or more and 1000 V or less, and the operating frequency is about 5 kHz or more and 100 kHz or less. The reactor 1 of the embodiment can be typically used as a constituent component of a converter installed in a vehicle, such as an electric automobile or a hybrid automobile, and a constituent component of a power converter device that includes this converter. The reactor 1 of the embodiment is excellent in the productivity and can therefore improve the productivity of the converter and the power converter device.

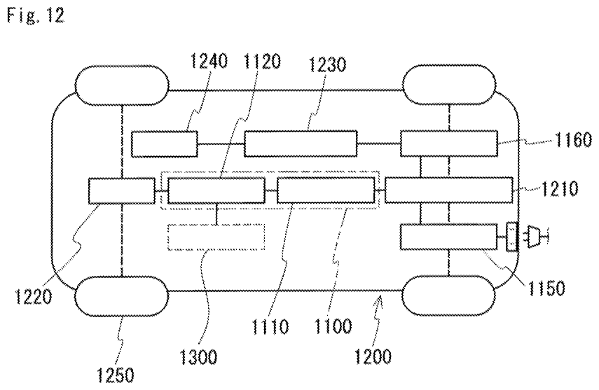

A vehicle 1200, such as a hybrid automobile or an electric automobile, includes a main battery 1210, a power converter device 1100 connected to the main battery 1210, and a motor 1220 that is used for travel and driven by electric power supplied from the main battery 1210, as shown in FIG. 12. The motor 1220 is, typically, a three-phase AC motor. The motor 1220 drives wheels 1250 during travel and functions as a generator during regeneration. In the case of a hybrid automobile, the vehicle 1200 includes an engine 1300 in addition to the motor 1220. In FIG. 12, an inlet is shown as a charging point of the vehicle 1200, but a mode of having a plug may alternatively be adopted.

The power converter device 1100 includes a converter 1110, which is connected to the main battery 1210, and an inverter 1120, which is connected to the converter 1110 and performs mutual conversion between direct current and alternating current. The converter 1110 described in this example boosts an input voltage of the main battery 1210 that is about 200 V or more and 300 V or less to about 400 V or more and 700 V or less, and supplies power to the inverter 1120 when the vehicle 1200 travels. During regeneration, the converter 1110 steps down an input voltage that is output from the motor 1220 via the inverter 1120 to a DC voltage appropriate for the main battery 1210, and charges the main battery 1210. The input voltage is a DC voltage. When the vehicle 1200 travels, the inverter 1120 converts the direct current boosted by the converter 1110 into a predetermined alternating current, and supplies power to the motor 1220. During regeneration, the inverter 1120 converts the alternating current output from the motor 1220 to a direct current and outputs the direct current to the converter 1110.

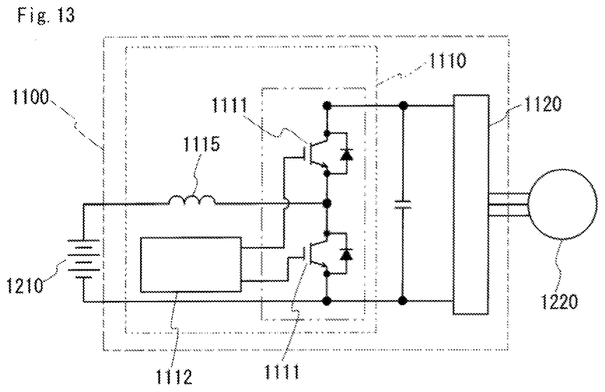

As shown in FIG. 13, the converter 1110 includes a plurality of switching elements 1111, a drive circuit 1112 that controls operation of the switching elements 1111, and a reactor 1115, and converts the input voltage by repeatedly turning on and off. Here, conversion of the input voltage refers to boosting and stepping down of the voltage. The switching element 1111 is a power device such as a field-effect transistor or an insulated gate bipolar transistor. The reactor 1115 has a function of smoothing a change in current when the current is about to increase or decrease due to a switching operation, using the property of the coil that prevents a change in a current flowing into the circuit. The reactor 1 of the embodiment is provided as the reactor 1115.

In addition to the converter 1110, the vehicle 1200 includes a converter 1150 for a power supply device that is connected to the main battery 1210, and a converter 1160 for an auxiliary equipment power supply that is connected to the main battery 1210 and a sub-battery 1230, which is a power source for auxiliary equipment 1240, and converts high voltage of the main battery 1210 to low voltage. The converter 1110 typically performs DC-DC conversion, while the converter 1150 for a power supply device and the converter 1160 for an auxiliary equipment power supply perform AC-DC conversion. Some type of converter 1150 for a power supply device also performs DC-DC conversion. Reactors that has the same configuration as the reactor 1 of the embodiment and has appropriately modified size, shape or the like can be used as the reactors of the converter 1150 for a power supply device and the converter 1160 for an auxiliary equipment power supply. Further, the reactor 1 of the embodiment can also be used in a converter that converts input power and only boosts or steps down voltage.

What is claimed is:

1. A reactor comprising:
a coil;
a holding member; and
a magnetic core on which the coil is disposed,
wherein the coil has:
a first terminal portion withdrawn from a first end of the coil; and
a second terminal portion withdrawn from a second end of the coil,
the first terminal portion is withdrawn from the first end in a direction orthogonal to an axis of the coil,
the holding member has:
a first holding member disposed at the first end; and
a second holding member disposed at the second end,
the first holding member has:
a first body portion in contact with the first end; and
a first insertion portion having a through-hole into which the first terminal portion is inserted,
the second holding member has:
a second body portion in contact with the second end,
either the first holding member or the second holding member has a first joint portion that is disposed along a part of an outer peripheral surface of the coil and connects between the first body portion and the second body portion,
either the first body portion or the second body portion and the first joint portion include portions of a first coupling structure that are fitted to each other, and
the first coupling structure includes a first recessed portion and a first protruding portion.

2. The reactor according to claim 1,
wherein the coil has a polygonal-tubular shape,
the outer peripheral surface of the coil has a plurality of faces including a first face,
the first terminal portion protrudes from the first face as viewed from a direction parallel with the axis of the coil,
the second holding member has the first joint portion disposed along the first face,
the first body portion has the first protruding portion, and
the first joint portion has the first recessed portion.

3. The reactor according to claim 2,
wherein the second holding member further has a second joint portion connecting between the first body portion and the second body portion,
the second joint portion is disposed along a second face of the outer peripheral surface, the second face being located on a side opposite to the first face,
the first body portion and the second joint portion include portions of a second coupling structure that are fitted to each other, and
the second coupling structure includes a second recessed portion and a second protruding portion.

4. The reactor according to claim 3,
wherein the first body portion has the second protruding portion,
the second joint portion has the second recessed portion, and
the second protruding portion is smaller than the first protruding portion.

5. The reactor according to claim 1,
wherein the coil has a polygonal-tubular shape,
the outer peripheral surface of the coil has a plurality of faces including a first face,
the first terminal portion protrudes from the first face as viewed from a direction parallel with the axis of the coil, and
the first holding member has the first joint portion disposed along the first face.

6. The reactor according to claim 1,
wherein the second terminal portion is withdrawn from the second end in a direction parallel with the axis of the coil, and
the second holding member has a second insertion portion having a through-hole into which the second terminal portion is inserted.

7. A converter comprising the reactor according to claim 1.

8. A power converter device comprising the converter according to claim 7.

9. A converter comprising the reactor according to claim 2.

10. A converter comprising the reactor according to claim 3.

11. A converter comprising the reactor according to claim 4.

12. A converter comprising the reactor according to claim 5.

13. A converter comprising the reactor according to claim 6.
